(19) United States
(12) Patent Application Publication
(10) Pub. No.: US 2016/0260365 A1
(43) Pub. Date: Sep. 8, 2016

(54) GATE DRIVING CIRCUIT, DISPLAY PANEL AND DISPLAY APPARATUS

(71) Applicants: BOE TECHNOLOGY GROUP CO., LTD., Beijing (CN); HEFEI XINSHENG OPTOELECTRONICS TECHNOLOGY CO., LTD., Hefei City, Anhui (CN)

(72) Inventor: Tong YANG, Beijing (CN)

(21) Appl. No.: 14/898,650

(22) PCT Filed: May 14, 2015
(86) PCT No.: PCT/CN2015/078995

§ 371 Date: Dec. 15, 2015

(30) Foreign Application Priority Data
Dec. 22, 2014 (CN) 201410808674.4

(51) Int. Cl. G09G 3/00

(52) U.S. Cl. CPC G09G 3/00; G09G 2300/04; G09G 2310/08

(57) ABSTRACT

A gate driving circuit, a display panel and a display apparatus, the gate driving circuit comprises a plurality of shift register units connected in cascades and at least one signal line used to input a control signal to the gate driving circuit; wherein the signal line has signal output branches whose number is less than the number of the shift register units; at least one of the signal output branches is connected to control signal input terminals corresponding to at least two shift register units, in this way, it is ensured that the phenomenon of signal intensity attenuation of at least part of shift register units can be reduced; the gate driving circuit can reduce the attenuation of output intensity of the respective control signals effectively, and can raise the uniformity of output intensity of the respective control signals effectively so that the quality of picture displayed by the display panel and the operation performance thereof are guaranteed, as compared with that the respective control signals are input from one terminal of the display panel and pass through the respective shift register units in the gate driving circuit sequentially in the prior art.

### TECHNICAL FIELD

The present disclosure relates to a field of display technique, in particular to a gate driving circuit, a display panel and a display apparatus.

### BACKGROUND

At present, display technology is applied widely to displaying of TV set, mobile phone and public information. A flat panel display used to display a picture is promoted vigorously due to its advantages of ultra thinness and energy efficiency. In most flat panel displays, it is needed to adopt a gate driving circuit to output a gate scanning signal, so as to control the display panel to realize functions of scanning progressively and refreshing frame by frame, so that image data input to the display panel is capable of being refreshed in real time, thereby implementing dynamic display. The gate driving circuit comprises a plurality of shift register units connected in cascades, and the function of gate driving is realized by means of the shift register units. In this way, not only the process of manufacturing a gate driving chip separately can be spared, but also a manufacturing process can be reduced. Such circuit can not only reduce the production cost of the flat panel display, but also shorten the production cycle. Therefore, the shift register technology is applied widely to flat panel display manufacturing in recent years.

However, when the design of the gate driving circuit is used for a large-size panel, by taking a clock control signal line as an example, since a signal line itself that transmits the clock control signal has a parasitic capacitor C and a resistor R, the intensity of the clock control signal would attenuate as the clock control signal is far away from an input terminal. Therefore, as the clock control signal is far away from a control signal input terminal, the intensity of the control signal would attenuate, and then the quality of the picture displayed on the display panel and its operation performance would be influenced.

Therefore, how to improve the problem that the intensity attenuation of the output control signal occurs in the gate driving circuit as the control signal is far away from the control signal input terminal thereby the quality of the picture displayed on the display panel and its operation performance are influenced is a problem to be solved urgently by those skilled in the art.

### SUMMARY

There are provided in embodiments of the present disclosure a gate driving circuit, a display panel and a display apparatus, which are used to solve the problem existing in the art that, as the control signal is far away from the control signal input terminal, the intensity attenuation of the output control signal occurs in the gate driving circuit, such that the quality of the picture displayed on the display panel and its operation performance are influenced.

There is provided in an embodiment of the present disclosure a gate driving circuit, comprising a plurality of shift register units connected in cascades and at least one signal line used to input a control signal to the gate driving circuit;

wherein the signal line has signal output branches whose number is less than the number of the shift register units; and

at least one of the signal output branches is connected to control signal input terminals corresponding to at least two shift register units.

In a possible implementation, in the gate driving circuit provided in the embodiment of the present disclosure, each of the signal output branches is connected to the control signal input terminals corresponding to at least two shift register units.

In a possible implementation, in the gate driving circuit provided in the embodiment of the present disclosure, each of the signal output branches is connected to control signal input terminals corresponding to a plurality of adjacent shift register units.

In a possible implementation, in the gate driving circuit provided in the embodiment of the present disclosure, at least one of the signal output branches is connected to control signal input terminals corresponding to a plurality of adjacent odd number stages of shift register units.

In a possible implementation, in the gate driving circuit provided in the embodiment of the present disclosure, at least one of the signal output branches is connected to control signal input terminals corresponding to a plurality of adjacent even number stages of shift register units.

In a possible implementation, in the gate driving circuit provided in the embodiment of the present disclosure, the number of control signal input terminals connected to respective signal output branches is the same.

In a possible implementation, in the gate driving circuit provided in the embodiment of the present disclosure, adjacent two signal output branches are connected to a control signal input terminal corresponding to a same shift register unit.

In a possible implementation, in the gate driving circuit provided in the embodiment of the present disclosure, when the signal line is a low level power supply signal line, a control signal input terminal corresponding to a shift register unit is a low level signal input terminal;

when the signal line is a high level power supply signal line, the control signal input terminal corresponding to the shift register unit is a high level signal input terminal;

when the signal line is a clock control signal line, the control signal input terminal corresponding to the shift register unit is a clock signal input terminal.

There is provided in an embodiment of the present disclosure a display panel, comprising the gate driving circuit provided in the embodiment of the present disclosure.

There is provided in an embodiment of the present disclosure a display apparatus, comprising the display panel provided in the embodiment of the present disclosure.

There are provided in the embodiments of the present disclosure a gate driving circuit, a display panel and a display apparatus. The gate driving circuit comprises a plurality of shift register units connected in cascades and at least one signal line used to input a control signal to the gate driving circuit; wherein the signal line has signal output branches whose number is less than the number of the shift register units; at least one of the signal output branches is connected to control signal input terminals corresponding to at least two shift register units. In this way, it can be ensured that the phenomenon of signal intensity attenuation in at least part of shift register units can be reduced. As compared with that the respective control signals are input from one terminal of the display panel and pass through the respective shift register units in the gate driving circuit sequentially in the prior art, the gate driving circuit provided in the embodiments of the present disclosure can reduce the attenuation of output intensity of the respective control signals effectively, and can raise the uniformity of output intensity of the respective control signals effectively, so that the driving capability of the gate driving circuit for the entire display panel can be raised, and the quality of picture displayed by the display panel and its operation performance are guaranteed.

### BRIEF DESCRIPTION OF THE DRAWINGS

FIG. 1 is a schematic diagram of a configuration of a known gate driving circuit;

FIG. 2 is a schematic diagram of capacitor and resistor generated by respective signal lines themselves in the circuit as shown in FIG. 1;

FIG. 3 is a schematic diagram of simulate waveforms of clock control signals of respective detection points over clock control signal lines in a gate driving circuit in the circuit as shown in FIG. 1;

FIG. 4 is a schematic diagram of a gate driving circuit provided in an embodiment of the present disclosure;

FIG. 5 is a schematic diagram of simulate waveforms of clock control signals of respective detection points over clock control signal lines in a gate driving circuit provided in an embodiment of the present disclosure;

FIG. 6 is a schematic diagram of a comparison result of delay times of clock control signals of respective detection points provided in an embodiment of the present disclosure and clock control signals of respective detection points in the prior art;

FIG. 7 is a schematic diagram of another gate driving circuit provided in an embodiment of the present disclosure.

### DETAILED DESCRIPTION

Specific implementations of a gate driving circuit, a display panel and a display apparatus provided in embodiments of the present disclosure will be described below in detail by combining with figures.

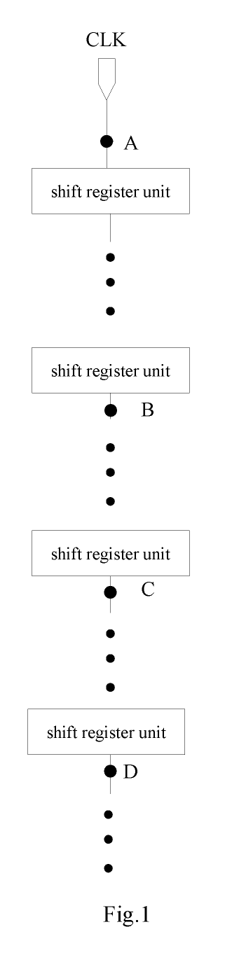

FIG. 1 shows a schematic diagram of a configuration of a known gate driving circuit. As shown in FIG. 1, by taking a clock control signal line as an example, four points A-D are selected as detection points over the clock control signal line at different positions. A clock control signal is input from one terminal of a display panel and passes through each shift register unit sequentially.

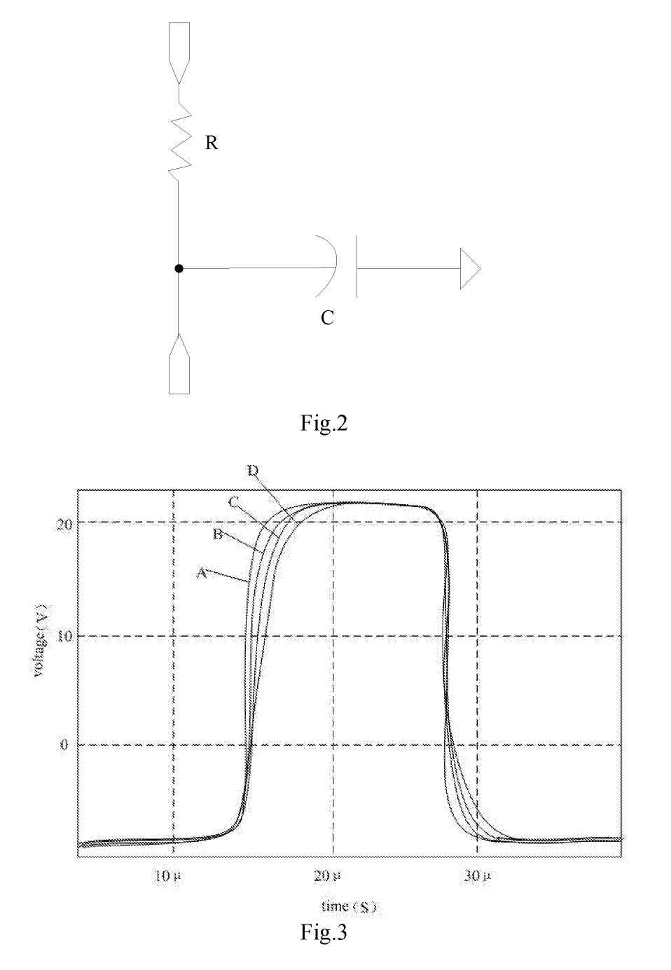

FIG. 2 shows a schematic diagram of capacitor and resistor generated by respective signal lines themselves in the circuit as shown in FIG. 1. As shown in FIG. 2, for clock signals input to respective shift register units, since the signal line itself that transmits a clock control signal has a parasitic capacitor C and a resistor R, the phenomenon of intensity attenuation would occur to the clock control signal as it is far away from the input terminal.

FIG. 3 shows a schematic diagram of simulate waveforms of clock control signals of respective detection points over the clock control signals in a gate driving circuit in the circuit as shown in FIG. 1.

For example, clock control signals at four detection points A-D in FIG. 1 can be simulated to obtain the waveform as shown in FIG. 3. It can be seen that as the detection point is far away from an input terminal, a waveform of a clock control signal which is far away from the input terminal and a waveform of a clock control signal which is close to the input terminal are quiet different, that is, there is a relatively large difference between the output intensity of the clock control signal at a close end of the input terminal and that at a far end of the input terminal. For the entire display panel, the quality of the displayed picture and the operation performance thereof often depend on an end where the output intensity of the control signal is the weakest, that is, the intensity of the control signal outputted by the far end of the input terminal determines the quality of the picture displayed on the display panel and its operation performance. Therefore, since the intensity of the control signal would attenuate as the control signal is far away from the control signal input terminal, the quality of the picture displayed on the display panel and its operation performance would be affected.

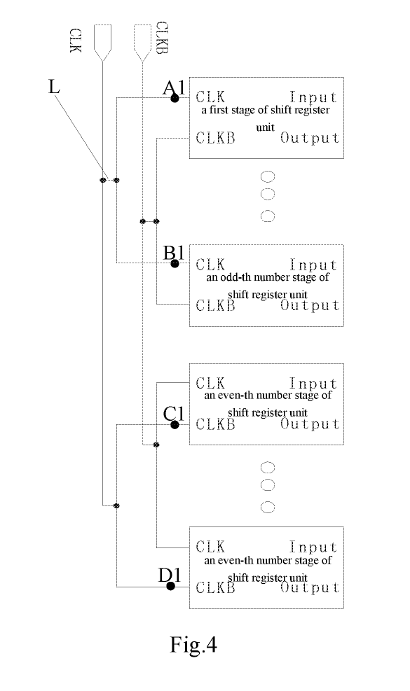

FIG. 4 shows a schematic diagram of a gate driving circuit provided in an embodiment of the present disclosure. The gate driving circuit comprises a plurality of shift register units connected in cascades and at least one signal line used to input a control signal to the gate driving circuit.

In the gate driving circuit as shown in FIG. 4, the signal line has signal output branches whose number is less than the number of the shift register units; at least one signal output branch is connected to control signal input terminals corresponding to at least two shift register units.

In the gate driving circuit provided in the embodiments of the present disclosure, because the signal line has signal output branches whose number is less than the number of the shift register units, and at least one of the signal output branches is connected to the control signal input terminals corresponding to at least two shift register units, the gate driving circuit provided in the embodiments of the present disclosure can ensure to reduce signal intensity attenuation phenomenon of at least part of shift register units, so that the driving capability of the gate driving circuit for the entire display panel can be raised, and the quality of picture displayed by the display panel and its operation performance are guaranteed, as compared with that the respective control signals are input from one terminal of the display panel and pass through the respective shift register units in the gate driving circuit sequentially in the prior art.

Exemplarily, in the gate driving circuit provided in the embodiments of the present disclosure, at least part of the signal output branches can be connected to control signal input terminals corresponding to a plurality of shift register units, and the remaining signal output branches are connected to control signal input terminals corresponding to the respective shift register units one by one correspondingly. In this way, the respective signal lines input the corresponding control signals to the control signal input terminals corresponding to the respective the shift register units through the respective signal output branches, so that it is capable of ensuring that signal intensity attenuation phenomenon of at least a part of shift register units is reduced.

As shown in FIG. 4 (the figure only shows clock control signal lines CLK and CLKB), in the gate driving circuit provided in the embodiments of the present disclosure, in order to reduce more effectively the intensity attenuation of control signals outputted from the respective signal lines at different positions and raise uniformity of output intensity of the respective control signals, the respective signal output branches can be connected to the control signal input terminals corresponding to at least two shift register units. That is, all the shift register units in the gate driving circuit can be grouped by taking at least two shift register units as a group, and the respective signal output branches are connected correspondingly to the control signal input terminals corresponding to the respective groups of shift register units. In this way, control signals over the respective signal lines can be assigned uniformly through the signal output branches, and then outputted to the corresponding control signal input terminals in the respective shift register units uniformly, so that the attenuation phenomenon in output intensity of the respective control signals can be reduced effectively, and uniformity of the output intensity of the respective control signals can be raised effectively.

Alternatively, in the gate driving circuit provided in the embodiment sof the present disclosure, in order to simplify the wiring manner of the respective signal lines, the respective signal output branches can be connected to the control signal input terminals corresponding to the a plurality of adjacent shift register units, that is, all the shift register units in the gate driving circuit can be grouped by taking at least two adjacent shift register units as a group, and the respective signal output branches are connected correspondingly to the control signal input terminals corresponding to the respective groups of shift register units. Such wiring manner can make the respective signal lines input control signals to the control signal input terminals corresponding to the respective shift register units through each signal output branch more uniformly, and the attenuation phenomenon in output intensity of the respective control signals can be reduced effectively, the uniformity of output intensity of the respective control signals can be raised effectively, and layout wiring of the gate driving circuit on the display panel can be made in good order.

As shown in FIG. 4 (the figure only shows clock control signal lines CLK and CLKB), in the gate driving circuit provided in the embodiments of the present disclosure, at least one of the signal output branches can be connected to control signal input terminals corresponding to a plurality of adjacent odd number stages of shift register units, or at least one of the signal output branches is connected to control signal input terminals corresponding to a plurality of adjacent even number stages of shift register units. In this way, it can be ensured that the signal intensity attenuation phenomenon of at least part of shift register units is reduced, so that the driving capability of the gate driving circuit for the entire display panel can be raised, and the quality of picture displayed by the display panel and its operation performance are guaranteed.

Alternatively, in the gate driving circuit provided in the embodiments of the present disclosure, in order to raise the intensity uniformity of the respective control signal inputted to the respective shift register units, the number of the control signal input terminals connected to the respective signal output branches can be made the same. That is, all the shift register units in the gate driving circuit can be grouped by taking at least two shift register units as a group, and the number of the shift register units contained in each group is the same. The respective signal output branches are connected to the control signal input terminals corresponding to the respective groups of shift register units correspondingly, so that each signal output branch outputs control signals to the corresponding signal input terminals having the same number. Therefore, the respective signal lines can assign the respective control signals uniformly and output them to the corresponding control signal input terminals in the respective shift register units through the respective signal output branches. In this way, the attenuation phenomenon in output intensity of the respective control signals can be reduced effectively, and uniformity of output intensity of the respective control signals can be raised effectively.

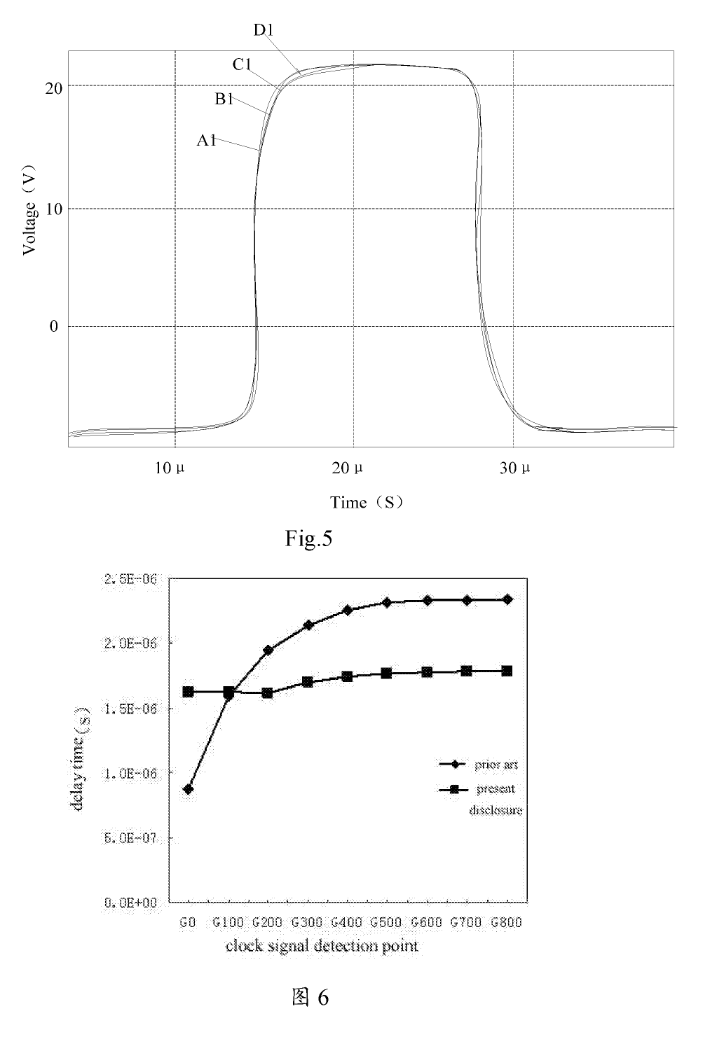

FIG. 5 shows a schematic diagram of simulate waveforms of clock control signals of respective detection points over the clock control signals in a gate driving circuit provided in an embodiment of the present disclosure. By taking the schematic diagram of the configuration of the gate driving circuit as shown in FIG. 4 as an example, the clock control signal waveform as shown in FIG. 5 is simulated and obtained by detecting the clock control signals of detection points over the clock control signal line CLK at different four positions A1-D1. It can be seen from FIG. 5 that the waveforms of the clock control signals at the respective detection points are basically consistent, and no relatively large difference occurs. Therefore, in the gate driving circuit provided in the embodiments of the present disclosure, the respective signal lines output to the respective corresponding control signal input terminals in the respective shift register units through a signal output branch L, so that the attenuation of output intensity of the control signal can be reduced effectively. The respective signal lines in the gate driving circuit provided in the embodiments of the present disclosure can output the respective control signals to the respective corresponding control signal input terminals in the respective shift register units through the signal output branch L, as compared with that the respective control signals are input from one terminal of the display panel and pass through the respective shift register units in the gate driving circuit sequentially in the prior art. In this way, the attenuation of output intensity of the respective control signals can be reduced effectively, and the uniformity of output intensity of the respective control signals can be raised effectively, so that the driving capability of the gate driving circuit for the entire display panel can be raised, and the quality of picture displayed by the display panel and its operation performance are guaranteed.

FIG. 6 shows a schematic diagram of a comparison result of delay times of clock control signals of respective detection points provided in an embodiments of the present disclosure and clock control signals of respective detection points in the prior art. Exemplarily, in order to describe more intuitively that the gate driving circuit provided in the embodiments of the present disclosure can reduce the attenuation of output intensity of the respective control signals effectively and can raise the uniformity of output intensity of the respective control signals effectively, for the gate driving circuit provided in the embodiments of the present disclosure and the gate driving circuit in the prior art, one detection point is selected at intervals of 100 shift register units, and totally nine detection points G0-G800 are selected to detect and simulate the clock control signal. High level rising edge time and falling edge time in waveforms of the respective detection points are measured, and the rising edge time and falling edge time of each detection point are summed and then compared. The comparison result is shown in FIG. 6. It can be seen that the delay times of the clock control signals outputted by the clock control lines at different positions in the gate driving circuit provided in the embodiments of the present disclosure are basically consistent, while the delay time of the clock control signal outputted by the clock control signal line in the gate driving circuit in the prior art increases as the clock control signal is far away from the input terminal. Thus it can be seen that the phenomenon of non-uniformity of the intensity attenuation would occur to the control signals outputted by the respective signal lines in the gate driving circuit in the prior art as the control signals are far away from the input terminal. In the gate driving circuit provided in the embodiments of the present disclosure, the shift register units in the entire gate driving circuit can be grouped by taking at least two shift register units as a group, and each signal output branch is connected to the corresponding control signal input terminals in a group of shift register units. In this way, the respective control signals can be outputted uniformly to the respective corresponding control signal input terminals in the respective shift register units through the signal output branches, so that the attenuation phenomenon of output intensity of the respective control signals can be reduced effectively, and the uniformity of the output intensity of the respective control signals can be raised effectively.

It needs to note that in the gate driving circuit provided in the embodiments of the present disclosure, the clock control signal lines CLK and CLKB can be connected alternatively to the clock signal input terminals of the respective shift register units. A practicable solution is as shown in FIG. 4. That is, the clock signal control line CLK is connected to the clock signal input terminal CLK of the odd number stages of shift register units and connected to the clock signal input terminal CLKB of the even number stages of shift register units. And the clock control signal line CLKB is connected to the clock signal input terminal CLKB of the odd number stages of shift register units and connected to the clock signal input terminal CLK of the even number stage of shift register units. The clock control signal lines CLK and CLKB output signals to the clock signal input terminals of the corresponding shift register units alternatively. In this way, it can ensure that the corresponding shift register units can output corresponding clock signals at respective moments.

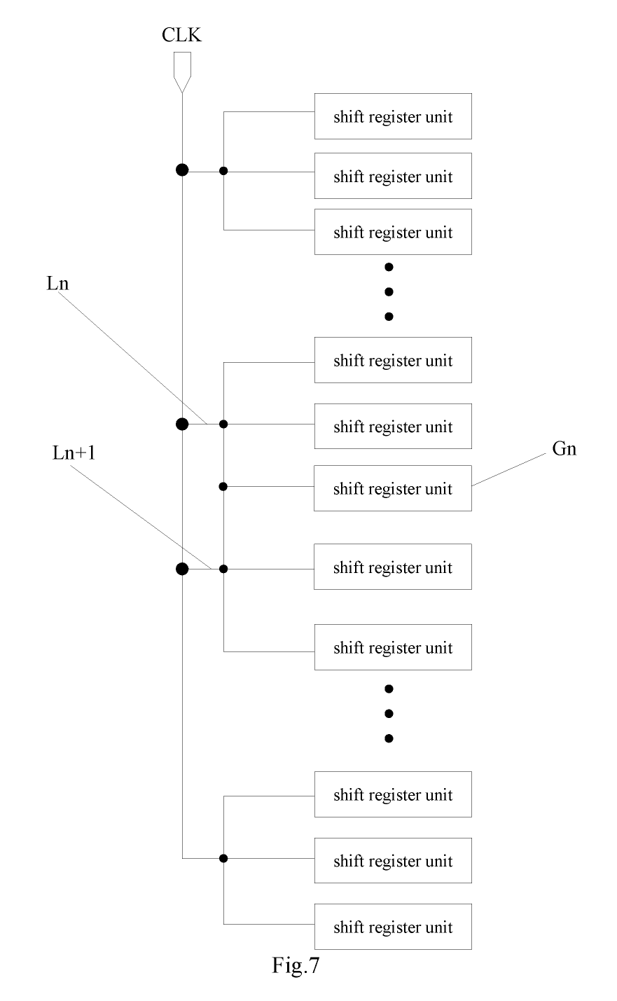

FIG. 7 shows a schematic diagram of another gate driving circuit provided in an embodiment of the present disclosure. As shown in FIG. 7, in the gate driving circuit provided in the embodiments of the present disclosure, in order to raise the uniformity of the output intensity of the respective control signals, the adjacent two signal output branches can be connected to the control signal input terminal corresponding to the same shift register unit. As shown in FIG. 7, only a clock control signal line CLK is shown. Two signal output branches Ln and Ln+1 of the clock signal control line CLK are connected to a signal input terminal of a shift register unit Gn. That is, in the a plurality of shift register units connected to two adjacent signal output branches, a control signal input terminal of a last stage of shift register unit connected to a previous signal output branch and a control signal input terminal of a first stage of shift register unit connected to a next signal output branch are a control signal input terminal of the same shift register unit. In this way, it is helpful to assign the control signals over the respective signal lines to the respective shift register units uniformly, so that the attenuation phenomenon in output intensity of the respective control signals can be reduced effectively, and the uniformity of the output intensity of the respective control signals can be raised effectively.

In a specific implementation, it is needed for the gate driving circuit provided in the embodiments of the present disclosure to realize the function of driving the display panel to display images normally under the control of the respective control signals. The signal lines that input control signals to the respective shift register units in the gate driving circuit comprise a low level power supply signal line, a high level power signal line, and a clock control signal line. If the signal line is the low level power signal line, then a control signal input terminal corresponding to a shift register unit connected to the signal line through a signal output branch is the low level signal input terminal; if the signal line is the high level power signal line, then a control signal input terminal corresponding to a shift register unit connected to the signal line through a signal output branch is the high level signal input terminal; if the signal line is the clock control signal line, then a control signal input terminal corresponding to a shift register unit connected to the signal line through a signal output branch is the clock signal input terminal. In this way, control signals over the respective signal lines can be outputted to the corresponding control signal input terminals in the shift register units through the respective signal output branches, to control the gate driving circuit to realize the function of driving normally the display panel to display images.

Based on the same inventive concept, there is provided in an embodiment of the present disclosure a display panel, comprising the gate driving circuit provided in the embodiment of the present disclosure. Since the principle of the display panel for solving the problem is similar to that of the gate driving circuit, the implementation of the display apparatus can refer to the implementation of the gate driving circuit described above, and thus repetitive descriptions are not further given.

Based on the same inventive concept, there is provided in an embodiment of the present disclosure a display apparatus, comprising the display panel provided in the embodiments of the present disclosure. The display apparatus can be any products or elements having a display function such as a mobile phone, a tablet computer, a television, a display, a notebook computer, a digital photo frame and a navigator and the like. Since the principle of the display apparatus for solving the problem is similar to that of the display panel, the implementation of the display apparatus can refer to the implementation of the display panel, and thus repetitive descriptions are not further given.

There are provided in the embodiments of the present disclosure a gate driving circuit, a display panel and a display apparatus. The gate driving circuit comprises a plurality of shift register units connected in cascades and at least one signal line used to input a control signal to the gate driving circuit. The signal line has signal output branches whose number is less than the number of the shift register units, and at least one of the signal output branches is connected to control signal input terminals corresponding to at least two shift register units. In this way, it is ensured that the phenomenon of signal intensity attenuation of at least part of shift register units can be reduced. Compared with that in the prior art, the respective control signals are input from one terminal of the display panel and pass through the respective shift register units in the gate driving circuit sequentially, the gate driving circuit provided in the embodiments of the present disclosure can reduce the output intensity attenuation of the respective control signals effectively, and can raise the uniformity of output intensity of the respective control signals effectively, so that the driving capability of the gate driving circuit for the entire display panel can be raised, and the quality of picture displayed by the display panel and its operation performance are guaranteed.

Obviously, those skilled in the art can make various amendments and modifications to the present disclosure without departing from the spirit and scope of the present disclosure. As such, if these amendments and modifications of the present disclosure belong to the scope of the claims of the present disclosure and their equivalent technology, the present disclosure intend to comprise these amendments and modifications.

The present application claims the priority of a Chinese patent application No. 201410808674.4 filed on Dec. 22, 2014. Herein, the content disclosed by the Chinese patent application is incorporated in full by reference as a part of the present disclosure.

1. A gate driving circuit, comprising:
a plurality of shift register units connected in cascades and at least one signal line used to input a control signal to the gate driving circuit, wherein
the signal line has signal output branches whose number is less than the number of the shift register units; and
at least one of the signal output branches is connected to control signal input terminals corresponding to at least two shift register units.

2. The gate driving circuit according to claim 1, wherein each of the signal output branches is connected to the control signal input terminals corresponding to at least two shift register units.

3. The gate driving circuit according to claim 1, wherein each of the signal output branches is connected to control signal input terminals corresponding to a plurality of adjacent shift register units.

4. The gate driving circuit according to claim 2, wherein at least one of the signal output branches is connected to control signal input terminals corresponding to a plurality of adjacent odd number stages of shift register units.

5. The gate driving circuit according to claim 2, wherein at least one of the signal output branches is connected to control signal input terminals corresponding to a plurality of adjacent even number stages of shift register units.

6. The gate driving circuit according to claim 2, wherein the number of control signal input terminals connected to respective signal output branches is the same.

7. The gate driving circuit according to claim 6, wherein adjacent two signal output branches are connected to a control signal input terminal corresponding to a same shift register unit.

8. The gate driving circuit according to claim 1, wherein when the signal line is a low level power supply signal line, a control signal input terminal corresponding to a shift register unit is a low level signal input terminal;
when the signal line is a high level power supply signal line, the control signal input terminal corresponding to the shift register unit is a high level signal input terminal; and
when signal line is a clock control signal line, and the control signal input terminal corresponding to the shift register unit is a clock signal input terminal.

9. A display panel, comprising the gate driving circuit according to claim 1.

10. A display apparatus, comprising the display panel according to claim 9.

11. The gate driving circuit according to claim 2, wherein when the signal line is a low level power supply signal line, a control signal input terminal corresponding to a shift register unit is a low level signal input terminal;
when the signal line is a high level power supply signal line, the control signal input terminal corresponding to the shift register unit is a high level signal input terminal; and
when signal line is a clock control signal line, and the control signal input terminal corresponding to the shift register unit is a clock signal input terminal.

12. The gate driving circuit according to claim 3, wherein when the signal line is a low level power supply signal line, a control signal input terminal corresponding to a shift register unit is a low level signal input terminal;
when the signal line is a high level power supply signal line, the control signal input terminal corresponding to the shift register unit is a high level signal input terminal; and
when signal line is a clock control signal line, and the control signal input terminal corresponding to the shift register unit is a clock signal input terminal.

13. The gate driving circuit according to claim 4, wherein when the signal line is a low level power supply signal line, a control signal input terminal corresponding to a shift register unit is a low level signal input terminal;
when the signal line is a high level power supply signal line, the control signal input terminal corresponding to the shift register unit is a high level signal input terminal; and
when signal line is a clock control signal line, and the control signal input terminal corresponding to the shift register unit is a clock signal input terminal.

14. The gate driving circuit according to claim 5, wherein when the signal line is a low level power supply signal line, a control signal input terminal corresponding to a shift register unit is a low level signal input terminal;
when the signal line is a high level power supply signal line, the control signal input terminal corresponding to the shift register unit is a high level signal input terminal; and
when signal line is a clock control signal line, and the control signal input terminal corresponding to the shift register unit is a clock signal input terminal.

15. The gate driving circuit according to claim 6, wherein when the signal line is a low level power supply signal line, a control signal input terminal corresponding to a shift register unit is a low level signal input terminal;
when the signal line is a high level power supply signal line, the control signal input terminal corresponding to the shift register unit is a high level signal input terminal; and
when signal line is a dock control signal line, and the control signal input terminal corresponding to the shift register unit is a dock signal input terminal.

19. The gate driving circuit according to claim 7, wherein when the signal line is a low level power supply signal line, a control signal input terminal corresponding to a shift register unit is a low level signal input terminal;
when the signal line is a high level power supply signal line, the control signal input terminal corresponding to the shift register unit is a high level signal input terminal; and
when signal line is a dock control signal line, and the control signal input terminal corresponding to the shift register unit is a dock signal input terminal.

17. The display panel according to claim 9, wherein each of the signal output branches is connected to the control signal input terminals corresponding to at least two shift register units.

18. The display pan& according to claim 9, wherein each of the signal output branches is connected to control signal input terminals corresponding to a plurality of adjacent shift register units.

19. The display panel according to claim 17, wherein at least one of the signal output branches is connected to control signal input terminals corresponding to a plurality of adjacent odd number stages of shift register units.

20. The display panel according to claim 17, wherein at least one of the signal output branches is connected to control signal input terminals corresponding to a plurality of adjacent even number stages of shift register units.
